(19) United States
(12) Patent Application Publication
(10) Pub. No.: US 2006/0174798 A1
(43) Pub. Date: Aug. 10, 2006

(54) Fire-resistant wall and method of manufacture

(75) Inventor: Christopher S. Churchill, Sacramento, CA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: GREENCOR COMPOSITES, LLC, SACRAMENTO, CA (US)

(21) Appl. No.: 11/294,292

(22) Filed: Dec. 5, 2005

Related U.S. Application Data
(63) Continuation-in-part of application No. 11/074,311, filed on Mar. 7, 2005.
Application No. 11/074,311 is a continuation of application No. 09/848,792, filed on May 4, 2001, now Pat. No. 6,886,306.

(51) Int. Cl. C09D 5/20

(52) U.S. Cl. 106/2

(57) ABSTRACT

The present invention is a fire-retardant wall having a fire-resistance rating of a least two hours and a method of making such a fire-retardant wall. The fire-retardant wall includes a first layer comprising an inner core, typically made of an insulated panel used in construction of buildings, and at least one second layer on each side of first layer, the at least one second layer further comprising at least one fire-resistant board of pressed milled straw, thereby forming the fire-retardant wall having a fire-resistance rating of at least two-hours. The second layer may also include a structural board used as a building panel in construction of buildings and/or an interior wall board used for internal and external walls and ceilings of buildings, wherein such boards are positioned on the exterior side of at least one board of pressed milled straw.

### CROSS-REFERENCE TO RELATED APPLICATION

This application is a continuation-in-part of prior U.S. application Ser. No. 11/074,311, filed Mar. 7, 2005 , herein incorporated by reference, which claims the benefit of U.S. application Ser. No. 09/848,792, filed May 4, 2001, now U.S. Pat. No. 6,886,306 issued May 3, 2005.

### STATEMENT REGARDING FEDERALLY SPONSORED APPLICATIONS

Not applicable.

### BACKGROUND OF THE INVENTION

The present invention relates generally to the field of building materials in general, and in particular to the introduction of straw, such as cereal straws (e.g., rice, wheat, oat, rye, barley), as a means of increasing the fire retardant qualities of such materials.

Straw is the above ground part of cereal and grass seed plants remaining after the grain or grass seed has been removed. Species of cereals and grasses providing straw include wheat, rice, rye, oats, barley, fescue, annual and perennial ryegrass, bluegrass and bentgrass. Although straw has been available in substantial quantities since the dawn of agriculture, only recently have straw-based cellulose materials been considered suitable for use in modern building materials. Until recently, the use of straw as a building material was not permitted due to a common perception that straw is an inherently inferior building material. Unlike wood-based cellulose materials, which have been used successfully for centuries, straw has not generally been considered useful because of the perception that straw lacked strength, durability, or fire retardance.

Contrary to conventional wisdom, however, recent experience with straw as a building material has shown that, when employed correctly, straw can be used very effectively in modem construction. One current method involves incorporation of entire straw bales into the walls of a house. Experience with this method has shown that sufficiently dense packing and size can provide the necessary strength and structural support required for home construction.

Another use includes forming a very thin panel of compressed straw in combination with a resin binder. Such panels have been shown to be useful as a core layer or core stock in a plywood laminate. These panels are then incorporated with stronger wood laminate layers for production of plywood. The cellulose fibers used here are typically derived from pulp, waste paper, spoiled paper, pulp sludge, linter, bagasse, and other such materials in addition to those derived from straw.

There remains the problem, however, with an inherent flammability of such cellulose-based materials. Current straw based building materials are not fire resistant. This is because traditional cellulose-based flame retardant materials have inherent drawbacks owing to fire-retardant additives incorporated therein. For example, 15 to 25% borate or boric acid is often added to a cellulose stock to make the material flame retardant. The inclusion of these fire-retardant additives renders the material highly hydroscopic, or water-absorptive. In addition, these materials tend to absorb more moisture over the course of time, which can cause significant dimensional changes in structures built with such materials.

Other additives/chemicals that typically improve fire retardance, including condensed ammonium phosphate, may be added to a cellulose-based material before thermal curing; however, this causes the chemical to react with or adhere to the surface of the cellulose fibers and, while, some of these chemical may reduce water absorption characteristics (as compared with the use of borate) there are now significant concerns about such chemical additives, their hazard and waste products, including cost of disposing such chemical waste making them undesirable for use. Furthermore, such chemical additives have not demonstrated a sufficient improvement in the fire retardance of cellulose-based materials to justify the their use in high-risk, commercial, residential and/or industrial environments. In fact, building materials using such chemicals are not sufficiently fire resistant to qualify for ratings at a higher end of a fire-resistance classification system supported by ASTM International.

Accordingly, there is a need for inexpensive, cost-effective and lightweight fire-retardant building materials that are capable of qualifying for a higher-end fire-resistance classification that is not excessively water absorptive and does not require costly or hazardous chemical additives for its manufacture.

### SUMMARY OF THE INVENTION

The present invention solves many problems associated with the current state of building materials that do not have a higher-end fire-resistance rating and, instead, are water absorptive and require large quantities of potentially hazardous chemical additives when manufactured.

The present invention provides a building material derived from cereal straw (e.g., rice, wheat, oat, rye, barley) that exhibits significantly improved fire-resistance properties over traditional straw-based materials currently being manufactured. The present invention uses cereal straw, such as that from rice, wheat, oat and barley, in place of comparable cellulose materials, in order to provide a wall material having a much higher fire-resistance rating. The increased fire-resistance of the wall material is significant enough that the volume of fire-resistance additives used in a portion of the wall are significantly reduced or even eliminated, as desired.

Generally and in one form, the present invention provides a fire endurance wall that qualifies as a 2-hour wall when subject to a standard fire exposure condition; the fire-endurance wall having fire endurance characteristics and a higher performance level than previously available walls provided as a similar building material.

In another form, the present invention provides a method of fabricating a fire-retardant wall from pressed milled straw prepared into boards, wherein the wall includes two pressed milled straw boards that sandwich an inner core of an insulated panel material. The insulated panel material may be may be one that is prefabricated (e.g., oriented strand boards surrounding an insulating material) or fabricated during assembly of the fire-retardant wall of the present invention. With the present invention, an insulated panel includes an interior insulating placed between two standard structural boards used in the construction of building.

In another embodiment, the present invention provides a fire-retardant wall that includes at least two pressed milled straw boards forming an outer layer around and sandwiching an inner core of insulated panel material. The outer layer may also include additional structural and/or fire-resistant materials (e.g., structural boards, interior panels, fire-resistant panels used in the construction of buildings). The additional structural and/or fire-resistant materials are added as new layers to the outer/exterior portions of the pressed milled straw boards and may be added to either the outer/exterior portion of one or both pressed milled straw boards. Examples of additional structural and/or fire-resistant materials used in construction of buildings are mat-formed panels made of fiber strands or oriented strand boards, interior wall boards used for internal walls and ceilings of buildings (e.g., gypsum board). The various layers (as boards or panels) are typically adhered together by glue or an equivalent means of affixing boards known to one of ordinary skill in the art.

With the present invention, a building material wall made substantially of pressed milled straw provides significant benefits with respect to both economy and ecology because the invention provided herein includes a material traditionally viewed as a waste material with no commercial value.

Those skilled in the art will further appreciate the above-noted features and advantages of the invention together with other important aspects thereof upon reading the detailed description that follows in conjunction with the drawings.

### BRIEF DESCRIPTION OF THE DRAWINGS

For more complete understanding of the features and advantages of the present invention, reference is now made to the detailed description of the invention along with the accompanying figures, wherein

FIG. 1 depicts a representative method of manufacture of a pressed milled straw board of the present invention;

FIG. 2 depicts a profile of one embodiment of a fire-retardant wall of the present invention

FIG. 3 depicts a profile of another embodiment of a fire-retardant wall of the present invention;

FIG. 4 depicts representative interior thermocouple data of a fire-retardant wall of the present invention as measured during a fire test;

FIG. 5 depicts representative unexposed surface thermocouple data of a fire-retardant wall of the present invention as measured during a fire test;

FIG. 6 depicts a view of a representative fire-retardant wall of the present invention at its unexposed surface as measured during a fire test one hour and fifty-five minutes into the test;

FIG. 7 depicts a view of a representative fire-retardant wall of the present invention at its exposed surface after a fire test; and

FIG. 8 depicts a view of a representative fire-retardant wall of the present invention at its unexposed surface after a fire test.

### DETAILED DESCRIPTION OF THE INVENTION

As described above, the present invention provides a building material derived from cereal straw that provides significantly improved fire-resistance properties to such building materials as compared with traditional straw-based materials currently in use. Because straw, as a by-product of food production, has traditionally been viewed as a waste material with no commercial value, the present invention also provides economical value to a building material.

The present invention uses cereal straw in the place of comparable cellulose materials to provide a building material wall with a higher level and rating for fire-resistance. The fire retardance and highly improved fire-resistance of the present invention is significant enough that the volume of fire-resistance additives required can be reduced or even eliminated in some cases. The present invention is practiced using all types of cereal straw, especially those having a relatively high silica content, such as rice, wheat and barley as well as oat and rye. In certain embodiments, a fire retardant wall, according to the present invention, may qualify as a 2-hour rated wall, which is a higher performance level than previously available to such walls.

In general, the present invention includes a wall assembly comprising two pressed milled straw boards surrounding an inner core comprised of an insulated panel. In another form, the present invention is a wall assembly comprising two pressed milled straw boards surrounding an interior made substantially of an insulating material, such as foam (e.g., of polyurethane, urea-formaldehyde, phenolic material, cementitious material; foaming insulation vehicles), insulating concrete forms, insulated concrete blocks, expanded polystyrene, glass fiber, mineral wool (e.g., glass wool, rock wool, slag, wool), plastic fiber, and natural fibers (e.g., cotton, wool, hemp, straw bales), as examples, which is placed between two structural boards used in the construction of building, such as oriented strand board (OSB) or gypsum board (drywall), as examples. The insulating material between two pieces of structural board is similar to a structural insulated panel (SIP) that provides for structural strength of a wall. The pressed milled straw boards surrounding the SIP provides for fire retardation at higher levels than found with current SIPs.

Typically an insulated panel with structural boards surrounding it (akin to an SIP) bums quickly; OSB bums within approximately five minutes when subjected to a standard fire exposure condition. In order for an SIP to have a fire-resistance rating of 1-hour (i.e., constructed such that it achieves a 1-hour fire resistance rating and is capable of limiting the spread of fire for one hour), drywall boards are placed on either side of a SIP. To date, there is no commercially available fiber-based SIP having a 2-hour fire resistance rating (i.e., constructed to achieve a 2-hour fire resistance rating and capable of limiting the spread of fire for two hours).

The present invention provides pressed milled straw boards on the exterior sides of an insulated panel sandwiched between two structural boards (e.g., an SIP) in order to achieve a 2-hour fire resistance rating. A pressed milled straw board on either side of the insulated panel that is sandwiched between two structural boards is at least as thick as a drywall board used to provide a 1-hour fire resistance rating to SIPs. Fire resistance is further improved by increasing the thickness of the pressed milled straw boards or by adding additional fire-resistance materials to the exterior of one or both of the pressed milled straw boards.

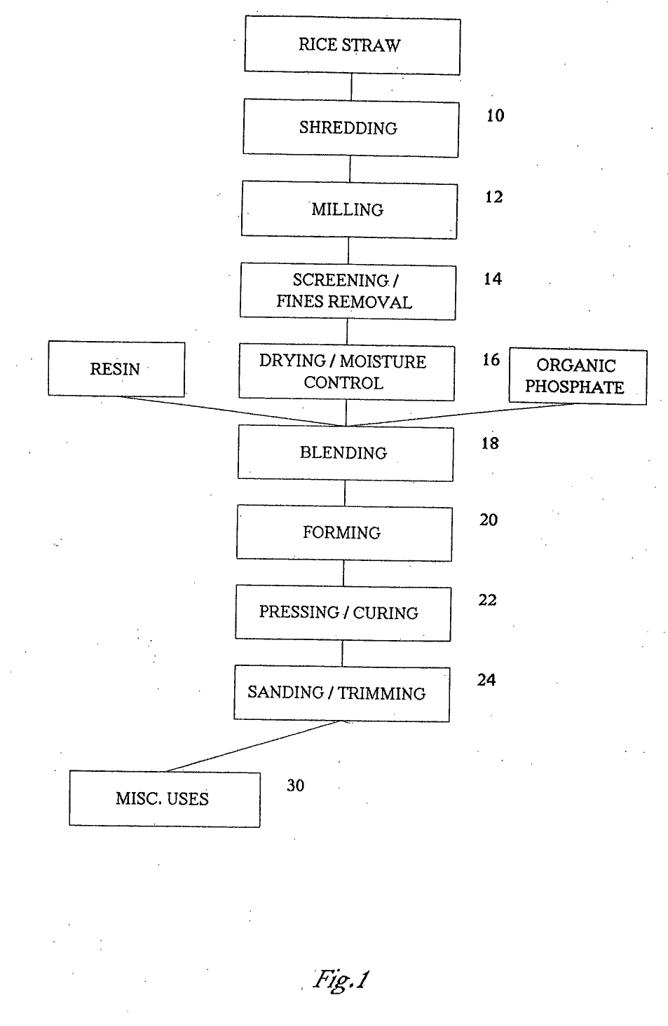

The pressed milled straw boards are prepared as described herein and in U.S. Pat. No. 6,886,306. A representative example for a method of manufacture of a pressed milled straw board is shown schematically in FIG. 1. As can be seen in this figure, straw panels (pressed milled straw board) manufactured according to the present invention are prepared by first shredding straw bales 10 and milling the straw to a desired fiber size range 12. After shredding 10 and milling 12, the milled straw may be screened so as to remove fines 14 and dried to a desired moisture content 16. Finally, the milled and dried straw is blended with an uncured resin binder 18, formed into a resin-straw mat of a suitable thickness 20, and cured at a suitable pressure and temperature 22. In certain embodiments, the process further comprises sanding and trimming the cured panel to a desired final thickness 24.

The straw used with the present invention were derived as a by-product of cereal production. Transverse cutting or chopping of the cereal straw was generally accomplished by using a forage harvester. The cut straw was then “baled,” or combined into manageable-bound chunks. After transportation to the processing plant, straw bales were broken down in a bale shredder. This process is represented in FIG. 1, block 10.

Following harvesting, baling, and bale-shredding, the straw is usually too long to be used for preparing a pressed milled straw board ; hence, the straw is typically in shortened prior to blending. This is done when pieces of straw exit the bale shredder, which were commonly greater than 3 inches—too long for producing boards of the present invention—and were reduced in size by some form of milling. The moisture content of the cereal straw may or may not be modified prior to milling to prevent thermal deterioration of the fibers.

The milling process, represented in FIG. 1, block 12, was accomplished using any milling device known in the art and capable of reducing the length of a straw stem, such as a hammermill. In addition, milling may be used to control the average length of the recovered straw segments by selecting appropriate milling conditions. Longitudinal straw cracking/splitting and node crushing can be accomplished by using grooved rollers, such as those found in grain roller mills and hay macerators, by using a sander having shear action, a disk waferizer, a ringflaker, a hammermill, or any other device capable of cutting the cereal straw into short segments.

The average straw segment size, not including fines, was typically between approximately 0.125 inches and approximately 1.5 inches, not including fines. In certain embodiments, milling was performed under conditions to minimize production of fines; however fines may be acceptable as part of the milled straw. By varying the segment size, performance characteristics of a pressed milled straw board of the present invention may be modified as desired.

Testing has shown that a presence of fines in the milled straw will not degrade performance of the pressed milled straw board (data not shown). Nonetheless, if the amount of fines present in the straw after milling effects the desired performance characteristics of a pressed milled straw board, the fines may be removed from the milled straw by screening, aeration, fractionation or other means of classification and separation well known to those skilled in the art. Classification and separation of fines may be performed either before or after milling, and is represented in FIG. 1, block 14.

In certain embodiments, the straw is split to ensure that all surfaces, exterior and interior, of the hollow straw stem (including core) are substantially coated with resin prior to curing. In addition, the straw may, in certain embodiments, be treated with a solvent wash or other process in such a manner as to strip some or all of the wax on the outside of the stem.

In certain embodiments, an intermediate orientation process may be provided by which the majority dimension of strands of straw are substantially oriented in a parallel fashion. For strands longer than approximately 0.04 inches, a specified degree straw strand orientation control is achieved with minor modifications to commercially available equipment traditionally used for orienting wood strands. This may also be accomplished by vibrating the strands on a corrugated panel or by tilting the panel. Alternatively, straw strands are dropped on parallel vertical bars placed in the form of a spaced grid with a distance less than the strand length. Shaking will then allow the straw to fall through. For strands shorter than approximately 0.04 inches, the straw is aligned by dropping the strands between vertical oppositely charged electric condenser panels. The dipole on the falling straw particles will align the particles parallel to an electric field provided by the oppositely charged electric condenser panels.

A drying/moisture control process represented in FIG. 1, block 16, provides a consistent level of quality for any board produced as described. Typically, straw moisture content is controlled to between three percent and eight percent of weight on an oven dry basis and is accomplished using any method commonly used in the art for adding and/or removing moisture from materials. The moisture content, prior to drawing, may range up to and greater than twelve percent by weight of the straw.

When desired, a high-temperature drying process may be used to reduce drying time. For example, milled straw fibers were dried convectionally under hot air at a temperature in the range of from about 200 degrees to 450 degrees Celsius. Depending on temperature, the drying time ranged from between approximately 20 seconds and approximately 10 minutes. Drying may also be carried out using any conventional method using any suitable heating device(s), alone or in combination, including a batch type heat circulator, tunnel type heat circulator, counter current convey type dryer, screw type heat conductive dryer, far-infra red radiation type dryer, and electrically heated rotary dryer.

After drying, the straw fiber is blended with a binder (typically a resin binder), as represented in FIG. 1, block 18. The binder may be any binder capable of providing a board having satisfactory performance characteristics, such as a polyisocyanate (e.g., polymeric diphenylmethane diisocyanate and polymethylene polyphenylene esters of isocyanic acid), phenol or a urea formaldehyde. In certain embodiments, a resin binder was added to the mixture at a rate of 2% to 10% of fiber weight on an oven-dried basis. The milled straw weight can be measured by a scale with a feedback control mechanism to regulate the rate at which the binder and other additives are added.

Examples of fire retardant additives include organic phosphate, a borate (e.g., zinc borate, boric acid), sodium silicates, aluminum trihydrate, or even cereal hulls. In addition, additives acting as extenders, such as dipropylene glycol monomethyletheracetate, waxes (e.g., paraffin) or release agents (e.g., to prevent the adhesion of the product to manufacturing equipment) are included with the binder. In a preferred embodiment, boards of the present invention do not require the addition of any such additives (e.g., organic phosphate, sodium silicates, aluminum trihydrate, or even cereal hulls) in order to achieve a desired higher level of fire retardancy.

After blending, the binder-straw fiber mixture is formed into a mat having a thickness and weight suitable for achieving a specified board thickness and density, as represented in FIG. 1, block 20. The formed mat is pressed and cured into a panel or board to a thickness usually thicker than the specified finished thickness. The curing process is represented in FIG. 1, block 22. One example of equipment useful for curing is a hot press. As appreciated by those skilled in the art, the curing process parameters will vary from one application to another. In one embodiment of the present invention, the formed mat was cured at a pressure ranging between approximately 300 and approximately 500 psi, a temperature of between approximately 250 and approximately 400 degrees Fahrenheit, and for a period of time ranging between approximately one to approximately three minutes.

Board thickness is achieved either by forming a cured mat at the desired thickness or by forming at a greater thickness and sanding one or both planar faces to remove enough material to achieve the desired thickness. The process in which the cured mat is thicker than that desired and sanded to a desired thickness after curing is represented in FIG. 1, block 24. The cured pressed milled straw board may require further trimming, as shown in block 24, to remove rough edges (e.g., unpressed material).

Pressed milled straw boards as described herein may be used, as represented by block 30, in a number of ways, including incorporation into one or more fire-retardant construction materials, such as doors, panels and walls. The thickness of the board will often depend on the use of the board. For example, a pressed milled straw board provided as a fire-retardant door has a typical thickness of approximately 1.5 inches.

When a pressed milled straw board of the present invention is manufactured as described above, a fire-retardant door comprising pressed milled straw board has been demonstrated to exhibit a level of fire resistance to qualify as a 45-minute door with a level of performance sufficient to qualify as Class 1 fire retardant material (see U.S. Pat. No. 6,886,306).

When a pressed milled straw board of the present invention is manufactured as described above and provided as a fire-retardant panel for general construction and other applications, the board is often thinner than when prepared as a fire-retardant door (e.g., less than one inch or approximately 0.1 inches to 0.50 inches thick). Thin panels have demonstrated a level of performance sufficient to qualify as Class 1 fire retardant material (data not shown).

When a pressed milled straw board of the present invention is manufactured as described above and provided as a fire-retardant wall, the board is typically thicker than that described for a fire-retardant panel (e.g., generally greater than 0.05 inches for an improved fire-resistance and often greater than one inch for even better fire-resistance rating as compared with comparable walls used in the construction of buildings). Such fire-retardant walls, as further describe below, have been shown to demonstrate a level of fire resistance to qualify as a 2-hour wall.

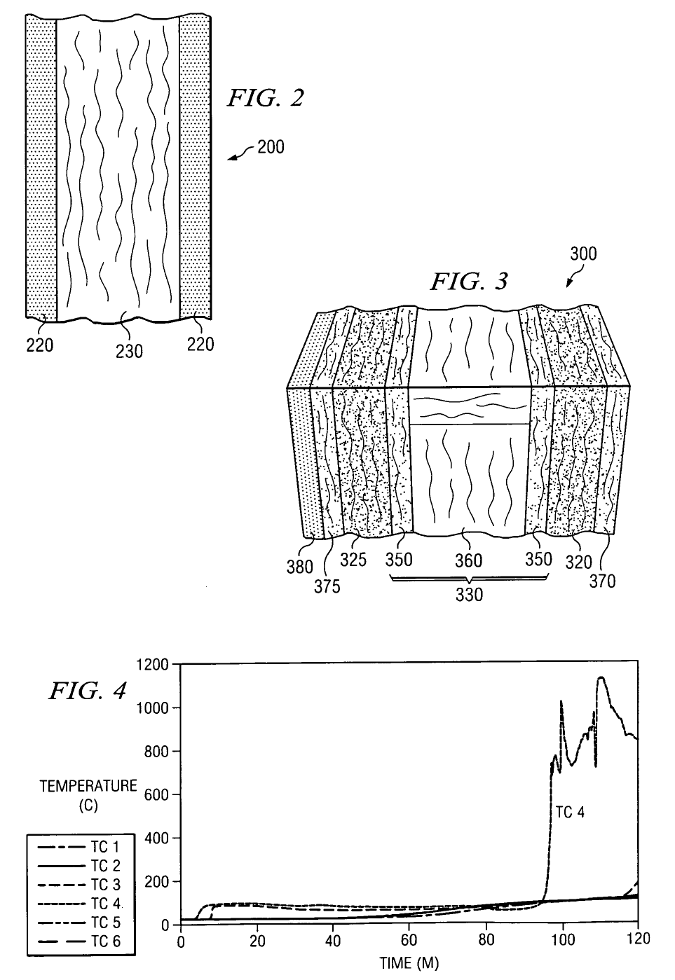

In an example of a fire-retardant wall of the present invention, the basic fire-retardant wall 200 comprises at least two pressed milled straw boards 220 surrounding an inner core 230 as depicted in FIG. 2. Inner core 230 is an insulated panel used in the construction of buildings and typically includes two standard width structural boards that sandwich at least one interior insulating material.

Referring now to FIG. 3, an example of a fabricated fire-retardant wall 300 of the present invention is shown. As in FIG. 2, the basic components of fire-retardant wall 300 include at least two pressed milled straw boards 320, 325, one on either side of an inner core 330. Inner core 330 comprises an insulated panel used in the construction of buildings. In FIG. 3, the insulated panel includes two standard width structural boards 350 on either side of interior insulating material 360. In the example shown in FIG. 3, the structural boards were OSB of about 7/16 inch, the pressed milled straw board was at least about 1 9/16 inch and made of rice straw using a method as described above and the interior material was expanded polystyrene foam. The visible 2 inch by 4 inch wood pieces shown in FIG. 2 for interior insulating material 360 were considered unessential for fire-retardance and merely introduced as connectors and for transport of the sample to the test site.

To evaluate fire endurance characteristics of a fire-retardant wall of the present invention, a fire-retardant wall sample 300 as shown in FIG. 3 was subjected to standard fire-exposure conditions as further described herein. The sample used in the fire test further comprised structural boards 370 and 375 (e.g., building panels used for construction of buildings) one each positioned adjacent to the exposed side of the pressed milled straw board 320 and 325 (FIG. 3). Structural boards 370, 375 were considered unessential for fire-retardance and comprised standard mat-formed panels made of fiber strands (e.g., OSB made of wood fiber); in this sample. The structural boards were merely used to provide additional structure and for transport of the sample to the test site.

Sample 300 of FIG. 3 also included at least one interior wall board 380 (e.g., wall board or panel used for internal walls and ceilings of buildings) positioned on one end of pressed milled straw boards 320. Interior wall board 380 was provided so that sample 300 was representative of an interior wall or exterior wall used in the construction of buildings. As with most interior and exterior wall boards, interior wall board 380 was made of a material that provided additional fire-resistance properties to sample 300. Examples of such materials include common soft sulfate minerals, such as crystalline calcium sulfate or hydrated calcium sulfate, also known as gypsum. For sample 300, interior wall board 380 was a gypsum (Type X) board of at least about ⅝ inches. In addition, boards or panels were affixed to each neighbor by use of a standard glue know to one of ordinary skill in the art. Alternative means of affixing or adhering the boards may also be used as is known to one of ordinary skill in the art, such as studs and nails.

A vertical small-scale positive pressure fire test was used that provided fire endurance conditions described by ASTM International using standards from ASTM E 119 “Fire Tests of Building Construction and Materials.” The test conditions were also closely described by testing standards UBC 7-1, 1997, UL 263, and NFPA 251. A vertical exposure furnace subjected samples to a standard time-temperature curve as specified in the referenced test procedures. Each test was to be performed for a period of at least 2 hours. A neutral pressure plane was maintained at a point ⅓ down the sample. A test sample was approximately 4 feet by 4 feet by 9½ inches (thick), fabricated using four panels (A, B, C, D) pieced together using studs as shown in FIG. 6 and tested in a room of ambient temperature.

The furnace used in the test was a reduced-scale fire burning apparatus fueled by natural gas. Each test sample was mounted onto a steel frame specimen holder and installed into the furnace vertically. The exposed surface of each test sample was subjected to a time-temperature curve, with temperature measurements taken inside the furnace using a number of thermocouples further described below connected to a computerized data acquisition system. Furnace valves were controlled based upon the average interior furnace temperature that was determined from five internal thermocouples. Furnace windows allowed viewing of the surface of the test sample. Upon completion of a test, a main gas supply valve was closed and the test sample unlatched from the furnace, allowing for extinguishment of the test sample and post-testing observations.

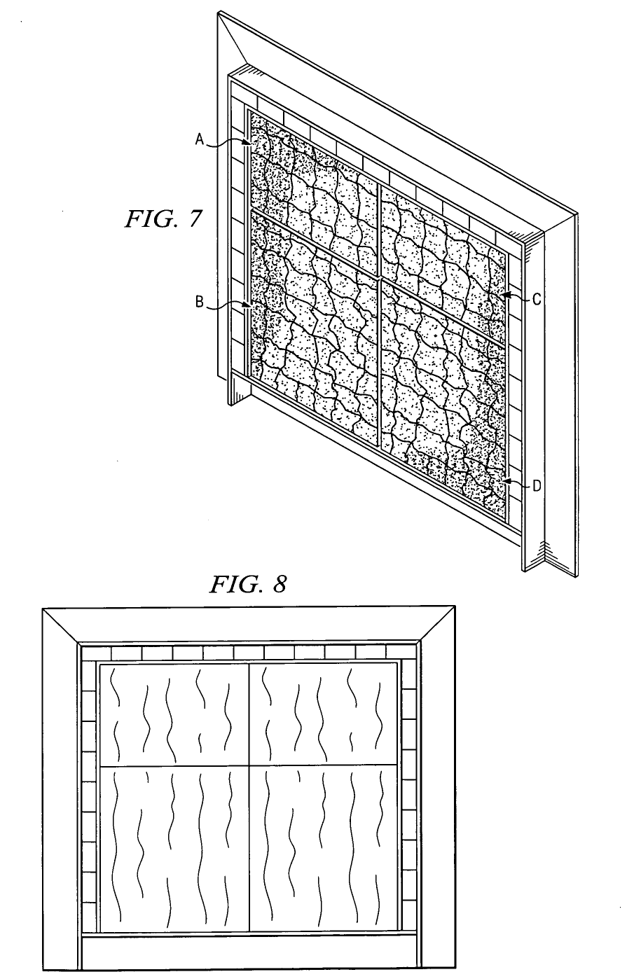

Six thermocouples (1-6) were placed inside a test sample during its construction to record temperatures of the sample itself during a test. Thermocouples (TC) 1-6 were not essential to a fire test in accordance with standards set by ASTM International; TC 1-6 were used merely for research purposes. These thermocouples (1-6) were analogous to ‘finish rating’ or ‘membrane protection’ thermocouples, and were located to obtain representative information on the temperature of the interface between the exposed pressed milled straw board and the insulated panel (330 of FIG. 3) being protected. Thermocouples 1, 2 and 5, 6 were placed at quarter points to a vertical center of each half of a panel, and were located in between pressed milled straw board 325 and insulated panel 330, which was on the side of the sample exposed to the furnace. Thermocouples 3 and 4 were placed at vertical quarter points on a face of a center stud between the stud and in between pressed milled straw board 325 and insulated panel 330. Hence, TC 3 and 4 were not well protected as compared with TC 1, 2, 5, and 6, since TC 3 and 4 were located at the interfaces or between fabricated panels of the sample (i.e., between panels A and C or between panels B and D as shown in FIG. 7).

FIG. 4 depicts thermocouple (TC) readings at the interior of the sample fire-retardant wall as measured by TC 1-6. The figure illustrates that the interior of the fire-retardant wall of the present invention successfully withstood a 2-hour exposure period without passage of flame or heat enough to ignite cotton waste. Measurements taken from thermocouples (1 -6) located on the inside of the sample (except TC 4 located over the center stud between panels B and D of FIG. 7 and approximately 12 inches above the base of the sample) indicated that insulated panel 330 of fire-retardant wall 300 as shown in FIG. 3 was well-protected from high temperatures. For TC 4, there appeared to be a breach in the protection provided by the fire-retardant wall that is due to the fact that TC 4 was located at a panel joint. Nonetheless, post-test observations, as further described below show that, as a whole, the fire-retardant wall of the present invention retained its structural integrity and would have withstood the impact of a hose stream exposure.

The essential thermocouples used for the fire-retardance test in accordance with the standards set forth by ASTM International were five thermocouples (7-11). TC 7-11 were placed on a sample's unexposed surface to record test temperatures provided by the furnace at the unexposed surface of the sample. For fire-retardant wall 300, TC 7-11 were placed on the exterior or exposed side of structural board 370. One thermocouple was centered (TC 9) and the remaining were placed at quarter-points about 12 inches from each side of the sample, including: (TC 7) at top left corner, (TC 8) at top right, (TC 10) at bottom left, and (TC 11) at bottom right. An example of the locations of TC 7-11 may be found at FIG. 6, with reference to the white squares positioned as described herein.

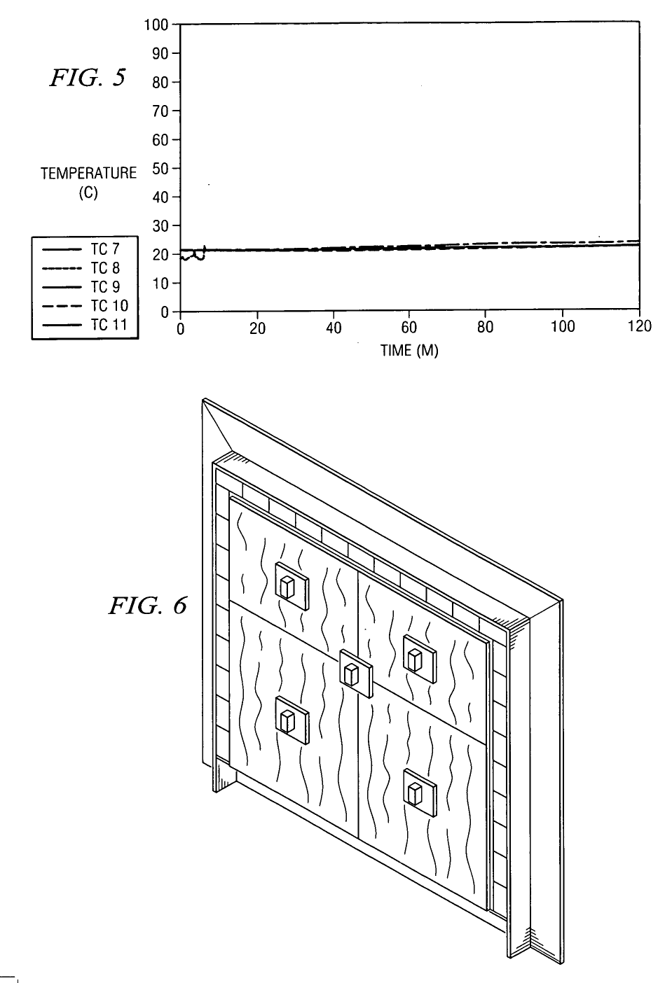

FIG. 5 depicts TC readings on the unexposed surface of the fire-retardant wall as measured by TC 7-11. The figure illustrates that the unexposed surface of the fire-retardant wall of the present invention did not receive temperatures above ambient levels and was thus protected by the fire-retardant wall of the present invention for at least 2 hours. FIG. 6 is a representative view of the unexposed surface of a sample one hour and fifty-five minutes into a test, indicating that there was no penetration of the fire onto this surface.

FIG. 7 depicts a view of a representative sample on its exposed surface after the fire test. The visible portion is the pressed milled straw board 325. Thus the fire-resistant nature of pressed milled straw board 325 (see FIG. 3) protected insulated panel 330 of FIG. 3 from fire.

Referring now to FIG. 8, another view of a representative sample on its unexposed surface after completion of the fire test is shown. Again, FIG. 8 shows that the fire-resistant wall of the present invention was capable of protecting the insulated panel from fire. Moreover, the fire test illustrates that a fire-retardant wall of the present invention achieves a fire-resistant rating of at least 2 hours in accordance with the standards provided by ASTM International.

Representative test values for a fire test of a fire-retardant wall sample as described in FIG. 3 are shown in TABLES 1, 2 and 3. The tables indicate that for this test, an average temperature of greater than 139° C. over the initial reading (ambient temperature reading) or a reading provided by a single thermocouple that is 30% above 139° C. over the initial reading (ambient temperature reading) may cause the fire-retardant wall to fail.

TABLE 1
Representative time and events table for a fire test.

| Test Time | |
|---|---|
| (h:mm:ss) | Event |
| 0:00:00 | Ignite Furnace, Test Started |
| 0:00:45 | Discoloration, darkening of exposed surface |
| 0:01:35 | Exposed surface is char colored |
| 0:24:30 | Steam or smoke from unexposed surface from lower left |
| | corner at TC hole |
| 0:26:15 | Horizontal crack forming in gypsum across center of exposed |
| | surface |
| 0:30:40 | Crevice in gypsum has ignited and spreading |
| 0:34:30 | Flaming at crevice across center of sample and across |
| | bottom edge of sample |
| 0:38:35 | Flames at all 4 perimeter edges of exposed surface |
| 0:48:30 | Smoke or steam from unexposed surface has ceased |
| 1:01:20 | Two additional crevices have formed on exposed |
| | surface upper and lower right hand corners |
| 1:09:50 | Exposed gypsum fell from sample |
| 2:00:00 | Stop Test |

TABLE 2
Representative interior temperature measurements of a fire-retardant wall
sample as recorded every five minutes by TC 1-6 during a fire test.

| Time | Temperature (Celsius) | | | | | |
|---|---|---|---|---|---|---|
| (h:mm:ss) | TC 1 | TC 2 | TC 3 | TC 4 | TC 5 | TC 6 |
| 0:00:00 | 23.0 | 23.1 | 23.6 | 23.4 | 23.1 | 22.8 |
| 0:05:00 | 22.9 | 23.1 | 23.6 | 57.1 | 23.0 | 22.8 |
| 0:10:00 | 22.9 | 23.1 | 83.9 | 90.5 | 22.9 | 22.7 |
| 0:15:00 | 22.8 | 23.0 | 83.9 | 92.1 | 22.8 | 22.7 |
| 0:20:00 | 22.8 | 23.0 | 81.0 | 90.9 | 22.8 | 22.6 |
| 0:25:00 | 22.9 | 23.0 | 74.0 | 85.9 | 22.8 | 22.7 |
| 0:30:00 | 22.9 | 23.0 | 66.0 | 79.3 | 22.9 | 22.8 |
| 0:35:00 | 23.1 | 23.2 | 62.2 | 80.4 | 23.0 | 23.0 |
| 0:40:00 | 23.5 | 23.5 | 59.9 | 76.8 | 23.4 | 23.3 |
| 0:45:00 | 24.1 | 24.1 | 58.9 | 73.0 | 24.0 | 23.9 |
| 0:50:00 | 25.0 | 25.2 | 58.3 | 70.3 | 24.9 | 25.0 |
| 0:55:00 | 26.6 | 27.1 | 58.0 | 68.5 | 26.9 | 27.4 |
| 1:00:00 | 29.3 | 32.0 | 58.0 | 67.4 | 32.5 | 34.2 |
| 1:05:00 | 34.0 | 43.8 | 58.6 | 67.6 | 44.0 | 46.4 |
| 1:10:00 | 41.0 | 56.6 | 60.1 | 67.9 | 55.0 | 58.4 |
| 1:15:00 | 49.9 | 66.5 | 62.7 | 66.2 | 63.8 | 68.3 |
| 1:20:00 | 60.3 | 74.3 | 67.1 | 61.6 | 71.2 | 76.2 |
| 1:25:00 | 70.8 | 80.3 | 72.9 | 54.2 | 77.2 | 82.1 |
| 1:30:00 | 79.8 | 85.2 | 80.3 | 57.7 | 82.6 | 86.8 |
| 1:35:00 | 86.7 | 89.4 | 86.4 | 108.1 | 87.4 | 90.6 |
| 1:40:00 | 91.9 | 92.9 | 93.5 | 940.4 | 91.3 | 93.7 |
| 1:45:00 | 95.7 | 95.7 | 93.7 | 821.8 | 94.5 | 96.4 |
| 1:50:00 | 98.4 | 97.9 | 98.3 | 1106.7 | 96.8 | 99.0 |
| 1:55:00 | 103.9 | 100.3 | 102.5 | 927.2 | 98.7 | 101.9 |
| 2:00:00 | 111.6 | 108.6 | 171.9 | 825.3 | 100.4 | 103.8 |
| MAX | 111.7 | 108.7 | 172.9 | 1116.6 | 100.5 | 103.9 |

TABLE 3
Representative unexposed surface temperatures of a fire-retardant wall
sample as recorded every five minutes by TC 7-11 during a fire test.

| Time | Temperature (Celsius) | | | | | |
|---|---|---|---|---|---|---|
| (h:mm:ss) | TC 7 | TC 8 | TC 9 | TC 10 | TC 11 | Average |
| 0:00:00 | 21.1 | 18.3 | 21.4 | 21.3 | 21.2 | 20.7 |
| 0:05:00 | 21.1 | 18.1 | 21.4 | 21.2 | 21.2 | 20.6 |
| 0:10:00 | 21.1 | 21.1 | 21.4 | 21.2 | 21.2 | 21.2 |
| 0:15:00 | 21.0 | 21.0 | 21.4 | 21.1 | 21.1 | 21.1 |
| 0:20:00 | 21.0 | 21.0 | 21.3 | 21.1 | 21.1 | 21.1 |
| 0:25:00 | 21.1 | 21.1 | 21.4 | 21.2 | 21.1 | 21.2 |
| 0:30:00 | 21.1 | 21.1 | 21.5 | 21.2 | 21.2 | 21.2 |
| 0:35:00 | 21.2 | 21.2 | 21.6 | 21.3 | 21.2 | 21.3 |
| 0:40:00 | 21.2 | 21.3 | 21.7 | 21.3 | 21.3 | 21.4 |
| 0:45:00 | 21.3 | 21.3 | 21.9 | 21.4 | 21.4 | 21.5 |
| 0:50:00 | 21.4 | 21.4 | 22.0 | 21.5 | 21.4 | 21.5 |
| 0:55:00 | 21.4 | 21.5 | 22.2 | 21.6 | 21.5 | 21.6 |
| 1:00:00 | 21.5 | 21.6 | 22.4 | 21.6 | 21.5 | 21.7 |
| 1:05:00 | 21.6 | 21.6 | 22.5 | 21.7 | 21.6 | 21.8 |
| 1:10:00 | 21.6 | 21.6 | 22.6 | 21.7 | 21.6 | 21.8 |
| 1:15:00 | 21.6 | 21.6 | 22.7 | 21.8 | 21.7 | 21.9 |
| 1:20:00 | 21.6 | 21.6 | 22.9 | 21.9 | 21.7 | 22.0 |
| 1:25:00 | 21.7 | 21.7 | 22.9 | 21.9 | 21.8 | 22.0 |
| 1:30:00 | 21.7 | 21.7 | 23.0 | 21.9 | 21.8 | 22.0 |
| 1:35:00 | 21.7 | 21.7 | 23.0 | 22.0 | 21.8 | 22.0 |
| 1:40:00 | 21.7 | 21.6 | 23.0 | 21.9 | 21.8 | 22.0 |
| 1:45:00 | 21.7 | 21.6 | 23.1 | 22.0 | 21.8 | 22.0 |
| 1:50:00 | 21.7 | 21.6 | 23.1 | 22.0 | 21.9 | 22.1 |
| 1:55:00 | 21.7 | 21.7 | 23.2 | 22.1 | 22.0 | 22.1 |
| 2:00:00 | 21.8 | 21.8 | 23.3 | 22.2 | 22.1 | 22.2 |
| MAX | 21.8 | 22.7 | 23.3 | 22.2 | 22.1 | 22.1 |

Accordingly, the present invention, comprising one or more pressed milled straw boards surrounding an inner core, is a fire-retardant building material for walls and demonstrates a level of fire resistance to qualify as a 2-hour wall. Alternative embodiments of the present invention include additional boards (e.g., structural boards and interior wall boards) on either one or both sides of each pressed milled straw board. It is envisioned that when additional boards such as interior wall boards having fire-resistant properties are included on the exposed exterior side of a fire-retardant wall of the present invention, the pressed milled straw board need not be exceptionally thick (substantially greater than 1 inch); in the absence of providing additional boards having fire-resistant properties, the pressed milled straw board should be at least as thick at the comparable thickness of a pressed milled straw board adjacent to an interior wall board having fire-resistant properties.

While particular embodiments of the invention and method steps of the invention have been described herein, additional alternatives not specifically disclosed but known in the art are intended to fall within the scope of the invention. Thus, it is understood that other embodiments and applications of the present invention will be apparent to those skilled in the art without departing from the scope and spirit of the appended claims and drawings.

What is claimed is:

1. A fire-retardant wall comprising:
a first layer comprising an inner core further comprising an insulated panel used in construction of buildings; and
at least one second layer on each side of first layer, the at least one second layer further comprising at least one fire-resistant board of pressed milled straw, thereby forming the fire-retardant wall having a fire-resistance rating of at least two-hours.

2. The fire-retardant wall of claim 1, wherein the pressed milled straw is a cereal straw selected from the group consisting of rice, wheat, oat, rye and barley.

3. The fire-retardant wall of claim 1, wherein the first layer is a structural insulated panel.

4. The fire-retardant wall of claim 1, wherein the board of pressed milled straw is at least about 0.5 inches in thickness.

5. The fire-retardant wall of claim 1, wherein the second layer further comprises a structural board used as a building panel in construction of buildings, the structural board positioned on an exterior side of at least one board of pressed milled straw.

6. The fire-retardant wall of claim 5, wherein the structural board is a mat-formed panel made of fiber strands.

7. The fire-retardant wall of claim 1, wherein the second layer further comprises an interior wall board used for internal and external walls and ceilings of buildings, the interior wall boards positioned on an exterior side of at least one board of pressed milled straw.

8. The fire-retardant wall of claim 7, wherein the interior wall board is fire-resistant.

9. The fire-retardant wall of claim 7, wherein the interior wall board is a gypsum board.

10. The fire-retardant wall of claim 1, wherein the pressed milled straw is made of straw having a longitudinal length of less than three inches.

11. The fire-retardant wall of claim 1, wherein the pressed milled straw is initially combined with a binder that makes up about 2% to about 10% of the dry weight of the milled straw.

12. The fire-retardant wall of claim 1, wherein the first layer and at least one second layer are affixed by glue or nails.

13. A method of making a fire-retardant wall comprising the steps of:
providing a first layer further comprising an insulated panel used in construction of buildings; and
adding at least one second layer on each side of the first layer, the second layer further comprising at least one fire-resistant board of pressed milled straw, thereby forming the fire-retardant wall having a fire-resistance rating of at least two-hours.

14. The method of claim 13, wherein the board of pressed milled straw is at least about 0.5 inches in thickness.

15. The method of claim 13, wherein the second layer further comprises a structural board used as a building panel in construction of buildings, the structural board positioned on an exterior side of at least one board of pressed milled straw.

16. The method of claim 15, wherein the structural board is a mat-formed panel made of strands of fiber.

17. The method of claim 13, wherein the second layer further comprises an interior wall board used for internal and external walls and ceilings of buildings, the interior wall board positioned on an exterior side of at least one board of pressed milled straw.

18. The method of claim 17, wherein the interior wall board is fire-resistant.

19. The method of claim 17, wherein the interior wall board is a gypsum board.

20. The method of claim 13, wherein the pressed milled straw is a cereal straw selected from the group consisting of rice, wheat, oat, rye and barley.
